(19) United States
(12) Patent Application Publication
(10) Pub. No.: US 2016/0050937 A1
(43) Pub. Date: Feb. 25, 2016

(54) TERMITICIDE AND PREPARATION CONTAINING SAME

(71) Applicant: Naofumi INOUE, (US)

(72) Inventor: Naofumi INOUE, Tokyo (JP)

(21) Appl. No.: 14/781,119

(22) PCT Filed: Mar. 17, 2014
(86) PCT No.: PCT/JP2014/057135

§ 371 Date: Sep. 29, 2015

(30) Foreign Application Priority Data
Apr. 1, 2013 (JP) 2013-086937

(51) Int. Cl. A01N 59/16; A01N 59/06; A01N 25/12

(52) U.S. Cl. CPC A01N 59/16; A01N 25/12; A01N 59/06

(57) ABSTRACT

Chemical agents are conventionally used to control or prevent termites. Potent agents such as organophosphorus compounds have been used. A termite control agent is provided that is not only high in control effect against termites but also safe to the human body. This is achieved by a termite control agent comprising particles containing two or more kinds of oxide or hydroxide which contain at least one kind of each of a first component and a second component, wherein the first component consists of zinc oxide or zinc hydroxide, and the second component consists of at least one kind of oxide or hydroxide of magnesium, calcium and aluminum.

### TECHNICAL FIELD

The present invention relates to a termite control agent and a preparation containing said control agent.

### BACKGROUND

Chemical agents are conventionally used to control or prevent termites. Potent agents such as organophosphorus compounds have been used. However, development of tolerance against the agent and safety to the human body became problematic, so that development of highly safe termite control agents is desired. Not only health damage of persons who are engaged in controlling termites but also health damage of public people who touch houses, wood and the like having been treated with a termite control agent is acknowledged as a problem. Heretofore, control agents employing calcium chloride have been known as control agents with less health damage to the human body. Control (preventing or repelling) activity of them is understood to be ascribable to the fact that when calcium chloride is absorbed, electrolyte balance in cells is lost, causing destruction of cell membranes. However, the control effect is not sufficient. Therefore, control agents are desired that are sufficient in control effect and safe to the human body. Though wood is an excellent constructional material that is sufficient in strength, low in cost and attractive in appearance, it has various problems in preservation. Among them, vulnerability to damages by injurious insects such as termites is a major problem. Therefore, a great number of trials to exterminate or control termites have been conducted. For example, chromated copper arsenate (CCA) wood-preserving agent, pentachlorophenol, creosote oil or the like are employed. However, in recent years, use of these substances has been acknowledged as a problem in view of health damage to the human body (Patent Document 1). As antimicrobial agents, compounds containing two or more kinds of oxide consisting of zinc oxide and oxide of magnesium, calcium and aluminum are known (Patent Document 2). However, though activity of these compounds as the antimicrobial agent is known, no example of control activity against injurious living organisms such as termites has been known yet. Further, though it is known that nanoparticulated zinc oxide has an insecticidal activity against termites, the effect is insufficient, and moreover, technology to manufacture it commercially is not satisfactory (Non-patent Document 1).

### PRIOR ART DOCUMENTS

### Patent documents

Patent Document 1: U.S. Pat. No. 4,950,685

Patent Document 2: U.S. Pat. No. 5,741,526

### Non-Patent documents

Non-patent Document 1: Clausen et al., Nanoscale Research Letters 2011, 6:427

### SUMMARy

An object of the present invention is to provide a termite control agent that is not only high in control effect against termites but also safe to the human body.

### Means to Solve the Problem

(1) The object is achieved by a termite control agent comprising particles containing zinc oxide or zinc hydroxide.

(2) The object is achieved by a termite control agent comprising particles containing two or more kinds of oxide or hydroxide which contain at least one kind of each of a first component and a second component, wherein the first component consists of zinc oxide or zinc hydroxide, and the second component consists of at least one kind of oxide or hydroxide of magnesium, calcium and aluminum.

(3) The object is achieved by a termite control agent of paragraph (2), wherein the second component of the particles is oxide or hydroxide of aluminum.

(4) The object is achieved by a termite control agent of any one of paragraphs (1) to (3), wherein the particles are oxide.

(5) The object is achieved by a termite control agent of paragraph (4), wherein the particles are represented by the following general formula (1):

(ZnO)₁₋ₓ(Al₂O₃)ₓ (1)

where x satisfies 0.005≦x<0.2.

(6) The object is achieved by a termite control agent of any one of paragraphs (1) to (5), wherein the particles are solid solution.

(7) The object is achieved by a termite control agent of any one of paragraphs (1) to (6), wherein primary particle size of the particles is 0.01 to 0.5 μm.

(8) The object is achieved by a termite control agent of any one of paragraphs (1) to (7), wherein the termite control agent contains polyvinyl alcohol.

(9) The object is achieved by an industrially applicable preparation containing a termite control agent of any one of paragraphs (1) to (8).

(10) The object is achieved by a termite control agent in a container equipped with spray means wherein a liquid composition containing a termite control agent of any one of paragraphs (1) to (8) is contained in the container.

### Advantageous Effect of the Invention

According to the present invention, by using a termite control agent containing zinc oxide or zinc hydroxide as an active component, a remarkably high control effect can be obtained, and safety to the human body is also secured. Further, the termite control agent of the invention significantly lowers activity of termites in the period between use of the termite control agent and death of termites, so that occurrence of feeding damage can be suppressed.

### DETAILED DESCRIPTION OF PREFERRED EMBODIMENTS

Hereinafter, the present invention will be described in detail.

The principal component of the termite control agent of the present invention is particles containing zinc oxide or zinc hydroxide. Hereafter, they will be referred to as “particles of the invention”. Further, the particles of the invention are particles containing two or more kinds of oxide or hydroxide which contain at least one kind of each of a first component and a second component, the first component consisting of zinc oxide or zinc hydroxide, and the second component consisting of at least one kind of oxide or hydroxide of magnesium, calcium and aluminum. Moreover, the second component of the particles of the invention is particles which are oxide or hydroxide of aluminum. Further, the particles of the invention are oxide. Further, the particles of the invention are particles represented by the following general formula (1):

(ZnO)₁₋ₓ(Al₂O₃)ₓ (1).

In the formula, x preferably satisfies 0.005≦x<0.2, more preferably 0.02≦x<0.1, and further preferably 0.04≦x<0.08. If x is 0.2 or more, control activity against termites is lowered. It is supposed that a reason for this is that the control activity against termites originates chiefly from zinc oxide in the particles of the invention. On the other hand, if x is less than 0.005, the control activity against termites is lowered; it is supposed that a reason for this is that dispersibility of the particles of the invention in aqueous dispersion liquid is reduced and average particle size is increased, and, as a result, surface area thereof is reduced so that number of reaction sites for the control activity against termites is reduced. Further, as the particles of the invention, particles of oxide or hydroxide composition containing magnesium and/or calcium, represented by the following formulae (2) and (3), are also preferable:

ZnₓN₁₋ₓO (2)

(in the formula, N denotes magnesium and/or calcium, and x satisfies 0.02<x<0.8),

ZnₓNi₁₋ₓ(OH)₂ (3)

(in the formula, N and x are the same as in formula (2)).

The particles of the invention are preferably solid solution. Definition of solid solution in the present invention will be described with reference to the compound of general formula (1). While the compound of formula (1) consists of zinc oxide and aluminum oxide, a compound for which, in X-ray diffraction analysis, intensity of diffracted characteristic X-ray of each of zinc oxide and aluminum oxide is reduced to 30% or less compared to that of a mixture measured to have the same composition, is regarded as solid solution. That is, in X-ray diffraction, solid solution means a compound in a state in which atoms (zinc and aluminum) in crystals are mixed uniformly. It is supposed that with both metal atoms being mixed uniformly at the atomic level, as well as small amount of aluminum oxide being present, dispersibility in water can be increased, and concerted effect of both metal ions on the surface controls termites promptly.

Average particle size of primary particles of the particles of the invention is preferably 0.01 to 0.5 μm, more preferably 0.01 to 0.2 μm, and further preferably 0.01 to 0.06 μm. The average particle size of primary particles was determined by selecting 50 or more particles in a random manner from scanning electron microscope photographs of the particles, calculating the diameter of a circle having the same area as the image of each particle, and regarding the diameter as the size of the particle. Particle size of the particles of the invention in aqueous dispersion liquid is determined by sampling the aqueous dispersion liquid, treating the liquid with ultrasonic waves for five minutes or more, and thereafter measuring the size by the laser scattering method.

For the particles of the invention, BET specific surface area is an important indicator. It is generally preferable that the BET specific surface area is large to enhance the control activity against termites. However, on the other hand, if the BET specific surface area is too large, the particles of the invention are sometimes aggregated so that practical surface area becomes small contrarily, lowering the control activity against termites. For these reasons, the BET specific surface area is preferably 1 to 300 m²/g, more preferably 3 to 150 m²/g, and still preferably 5 to 80 m²/g. As a method of manufacturing the particles of the invention, the method described in Patent Document 2 can be employed. When the particle size is small, total surface area is large. It is supposed that the control activity against termites occurs at the surface of the particles of the invention, so that the smaller the particle size is, the larger the control activity against termites is. However, when the primary particle size gets small to a certain extent or further, the particles tend to be aggregated because of their large surface area, so that the practical surface area in use tends to be reduced contrarily. It is supposed that, for this reason, an optimum range exists in the size of the particles of the invention.

It is preferable that the particles of the invention are subjected to surface processing. Examples of agents preferably used for surface processing are as follows. Higher fatty acids having ten or more carbon atoms such as stearic acid, erucic acid, palmitic acid, lauric acid and behenic acid; alkali metal salts of the higher fatty acids; sulfuric acid ester salts of higher alcohols such as stearyl alcohol and oleyl alcohol; anionic surfactants such as sulfuric acid ester salts of polyethylene glycol ether, sulfuric acid ester salts of amide-bonded compounds, sulfuric acid ester salts of ester-bonded compounds, sulfonates of ester-bonded compounds, sulfonic acid salts of amide-bonded compounds, sulfonic acid salts of ether-bonded compounds, alkylarylsulfonic acid salts of ether-bonded compounds, alkylarylsulfonic acid salts of ester-bonded compounds and alkylarylsulfonic acid salts of amide-bonded compounds; phosphoric acid esters such as an acid form, alkali metal salts or amine salts of monoester or diester of orthophosphoric acid with oleyl alcohol or stearyl alcohol or a mixture of both; silane coupling agents such as vinylethoxysilane, vinyl-tris (2-methoxy-ethoxy)silane, gamma-methacryloxypropyltrimethoxysilane, gamma-aminopropyltrimethoxysilane, beta-(3,4-epoxycyclohexyl)ethyltrimethoxysilane, gamma-glycidoxypropyltrimethoxysilane, and gamma-mercaptopropyltrimethoxysilane; titanate coupling agents such as isopropyltriisostearoyl titanate, isopropyltris(dioctylpyrophosphate)titanate, isopropyltri(N-aminoethyl-aminoethyl)titanate, and isopropyltridecylbenzenesulfonyl titanate; aluminum-based coupling agents such as acetoalkoxyaluminum diisopropylate; and esters of polyhydric alcohol with fatty acid such as glycerol monostearate and glycerol monooleate. Surface processing by at least one kind of the surface processing agents selected from the group consisting of higher fatty acids, anionic surfactants, phosphoric acid esters, coupling agents (silane, titanate and aluminum-based) and esters of polyhydric alcohol with fatty acid, among the agents listed above, is preferable, and surface processing by higher fatty acids having ten or more carbon atoms such as stearic acid, erucic acid, palmitic acid, lauric acid and behenic acid and alkali metal salts of the higher fatty acids is especially preferable.

It is preferable to use a surfactant when the particles of the invention are dispersed in a solvent such as water or the like. Amount of the surfactant is preferably 0.5 to 5% by weight or so in the termite control agent, and more preferably 1 to 3% by weight or so, but not limited thereto. As the surfactant, any of an anionic surfactant, a non-ionic surfactant, an amphoteric surfactant and a cationic surfactant can be used. Further, either of a low-molecular surfactant and a macromolecular surfactant can be used. It is possible to use one kind of these surfactants or two or more kinds in mixture. Among an anionic surfactant, a non-ionic surfactant, an amphoteric surfactant and a cationic surfactant, an anionic surfactant and a non-ionic surfactant are preferable in light of stability of dispersion, and an anionic surfactant is more preferable. Among anionic surfactants, an anionic surfactant of carboxylic acid type is especially preferable. Further, it is preferable to add 1 to 10% by weight of alcohol such as methyl alcohol, ethyl alcohol, propyl alcohol and isopropyl alcohol to a dispersion liquid of the particles of the invention in order to prevent sedimentation. It is also preferable to use an ultrasonic disperser in addition to a usual stirrer in order to improve dispersion state.

The anionic surfactants that can be used in the invention include surfactants of carboxylic acid type, sulfonic acid type, sulfonic acid ester type and phosphoric acid ester type. To be specific, examples are fatty acid soap such as sodium laurate and sodium palmitate; higher alkyl sulfuric acid ester salts such as sodium lauryl sulfate and potassium lauryl sulfate; alkyl ether sulfuric acid ester salts such as polyoxyethylene lauryl sulfate triethanolamine and sodium polyoxyethylene lauryl sulfate; N-acylsarcosine acids such as sodium lauroyl sarcosinate; higher fatty acid amidosulfonic acid salts such as sodium N-myristoyl-N-methyltaurate, sodium coconut oil fatty acid methyltauride and sodium laurylmethyltauride; phosphoric acid ester salts such as sodium polyoxyethylene oleyl ether phosphate and sodium polyoxyethylene stearyl ether phosphate; sulfosuccinic acid salts such as sodium di-2-ethylhexyl sulfosuccinate, sodium monolauroyl monoethanolamide polyoxyethylene sulfosuccinate, and sodium lauryl polypropylene glycol sulfosuccinate; alkylbenzenesulfonic acid salts such as sodium linear dodecylbenzenesulfonate and triethanolammonium linear dodecylbenzenesulfonate; N-acylglutamic acids such as monosodium N-lauroylglutamate and disodium N-stearoylglutamate; higher fatty acid ester sulfuric acid ester salts such as sodium hydrogenated coconut oil fatty acid glycerol sulfate; polyoxyethylene alkyl ether carboxylic acid salts; a-olefin sulfonic acid salts; higher fatty acid ester sulfonic acid salts; secondary alcohol sulfuric acid ester salts; higher fatty acid alkylolamide sulfuric acid ester salts; sodium lauroyl monoethanolamidosuccinate; N-palmitoylaspartic acid; ditriethanolamine; coconut oil fatty acid collagen hydrolysis alkali salts, and the like.

As the anionic surfactant of carboxylic acid type that can be used in the invention, those having five to thirty carbon atoms are preferable. To be specific, caprylic acid, nonanoic acid, capric acid, undecanoic acid, lauric acid, tridecanoic acid, myristic acid, pentadecyl acid, palmitic acid, palmitoyl acid, margaric acid, stearic acid, oleic acid, vaccenic acid, linoleic acid, linolenic acid, eleostearic acid, nonadecanoic acid, icosanoic acid, behenic acid, erucic acid, and coconut oil fatty acid and salts thereof are preferable. As the salts, sodium salts or potassium salts of these acids are preferable.

The non-ionic surfactants that can be used in the invention include, for example, compounds containing polyethylene oxide; block copolymers of polyethylene oxide-polypropylene oxide; polyoxyethylene sorbitan fatty acid esters; sorbitan fatty acid esters; sucrose fatty acid ester; fatty acid amide diethanol; acylglucoside; and polyoxyethylene hardened castor oil, and especially preferable are compounds containing polyethylene oxide, block copolymers of polyethylene oxide-polypropylene oxide and sucrose fatty acid ester.

Thickening agents, adhesive agents, dispersing agents, antifreezing agents, antiseptic agents, antifungal agents, specific gravity-regulating agents, antimicrobial agents, insect repelling agents, stabilizing agents, antifoaming agents, organic solvents, flavoring agents, coloring agents and the like are not particularly limited, and known additives being employed for their own use can be employed. Examples of the thickening agents include polyoxyethylene fatty acid esters, sodium polyacrylate, polyvinyl alcohol and xanthane gum, but not limited thereto. Blending ratio of the thickening agent is, for example, 200 parts by weight or less relative to 100 parts by weight of the particles of the invention, preferably 20 to 150 parts by weight, but not limited thereto.

It is preferable that macromolecules are contained as the dispersing agent or the adhesive agent in the termite control agent of the present invention in view of increasing persistence of the control effect against termites. As the macromolecule, various kinds are used; water-soluble macromolecules are preferable, and for example, casein, gelatin, starch, algin acid, carboxymethylcellulose, agar, polyvinyl alcohol, pine oil and the like can be used as necessary. Preparation of the dispersion liquid may be performed by placing the components listed above in a known agitating and mixing device and agitating and mixing them appropriately.

The termite control agent having been prepared as a dispersion liquid may be used as it is or may be used after drying. Further, it may be used as a mixture with one or more kinds of additional active components (for example, insecticides, bactericides, synergists, herbicides or plant growth regulators) as necessary. Examples of suitable insecticides are pyrethroids (e.g., permethrin, cypermethrin, fenvalerate, esfenvalerate, deltamethrin, cyhalothrin (especially X-cyhalothrin), bifenthrin, fenpropathrin, cyfluthrin, tefluthrin, pyrethroids (e.g., ethofenprox), natural pyrethrin, tetramethrin, s-bioallethrin, fenfluthrin, prallethrin, or 5-benzyl-3-furylmethyl-(E)-(1R, 3S)-2,2-dimethyl-3-(2-oxothiolane-3-ylidenemethyl)cyclopropanecarboxylate); organophosphorus compounds (e.g., profenofos, sulprofos, acephate, methyl parathion, azinphos-methyl, demeton-S-methyl, heptenophos, thiometon, fenamiphos, monocrotophos, profenofos, triazophos, methamidophos, dimethoate, phosphamidon, malathion, chlorpyrifos, phosalone, terbufos, fensulfothion, fonofos, phorate, phoxim, pirimiphos-methyl, pirimiphos-ethyl, fenitrothion, fosthiazate, or diazinon); carbamates (including aryl cabamate) (e.g., pirimicarb, triazamate, chloethocarb, carbofuran, furathiocarb, ethiofencarb, aldicarb, thiophlox, carbosulfan, bendiocarb, fenobcarb, propoxur, methomyl, or oxamyl); benzoylureas (e.g., diflubenzuron, triflumuron, hexaflumuron, flufenoxuron, or chlorfluazuron); pyrazoles (e.g., tebufenpyrad and fenpyroximate); macrolides (e.g., avermectin or milbemycin (e.g., abamectin, emamectin, benzoate, ivermectin, milbemycin, spinosad, azadirachtin, or spinetoram)); hormones or pheromones; organochloride compounds (e.g., endosulfan (especially a-endosulfan), benzene hexachloride, DDT, chlordane, or dieldrin); amidines (e.g., chlordimeform or amitraz); fumigants (e.g., chloropicrin, dichloropropane, methyl bromide, or metam); neonicotinoid compounds (e.g., imidacloprid, thiacloprid, acetamiprid, nitenpyram, dinotefuran, thiamethoxam, clothianidin, nithiazine, or flonicamid); diacylhydrazines (e.g., tebufenozide, chromafenozide or methoxyfenozide); diphenyl ethers (e.g., diofenolan or pyriproxyfen); indoxacarb; chlorfenapyr; pymetrozine; spirotetramat, spirodiclofen or spiromesifen; diamides (e.g., flubendiamide, chlorantraniliprole or cyantraniliprole); sulfoxaflor; or metaflumizone. Specific examples of bactericides are zoxamide, acibenzolar S-methyl, alanycarb, aldimorph, anilazine, azaconazole, azoxystrobin, fluoxastrobin, picoxystrobin, orysastrobin, metominostrobin, pyraclostrobin, trifloxystrobin, benalaxyl, benomyl, biloxazol, bitertanol, bromuconazole, bupirimate, captafol, captan, carbendazim, carbendazim chlorhydrate, carboxin, quinomethionate, chlorothalonil, chlorozolinate, clozylacon, copper-containing compounds (e.g., copper oxychloride, copper oxyquinolate, copper sulfate, copper tallate and bordeaux mixture), cymoxanil, cyproconazole, cyprodinil, debacarb, dichlofluanid, diclomezine, dichloran, diethofencarb, difenoconazole, difenzoquat, diflumetorim, dimefluazole, dimetconazole, dimethomorph, dimethirimol, diniconazole, dinocap, dithianon, dodecyldimethylammonium chloride, dodemorph, dodine, doguadine, edifenphos, epoxiconazole, ethirimol, etridiazol, famoxadone, fenamidone, fenarimol, fenbuconazole, fenfuram, fenhexamid, fenpiclonil, fenpropidin, fenpropimorph, ferimzone, fluazinam, fludioxonil, flumetover, fluoroimide, fluquinconazole, flusilazole, flutolanil, flutriafol, folpet, fuberidazole, furalaxyl, furametpyr, guazatine, hexaconazole, hydroxyisoxazole, hymexazol, imazalil, imibenconazole, iminoctadine, iminoctadine triacetate, ipconazole, iprobenfos, iprodione, iprovalicarb, isopropanylbutyl carbamate, isoprothiolane, kasugamycin, kresoxim-methyl, mancozeb, maneb, mefenoxam, mepanipyrim, mepronil, metalaxyl, metconazole, metiram, metiram zinc, metominostrobin, myclobutanil, neoasozin, nickel dimethyldithiocarbamate, nitrothal-isopropyl, nuarimol, ofurace, oxadixyl, oxasulfuron, oxolinic acid, oxpoconazole, oxycarboxin, pefurazoate, penconazole, pencycuron, phenazine oxide, fosetyl-Al, phosphorous acid, fthalide, polyoxin D, polyram, probenazole, prochloraz, procymidone, propamocarb, propiconazole, propineb, propionic acid, pyrazophos, pyrifenox, pyrimethanil, pyroquilone, pyroxyfur, pyrrolnitrin, quaternary ammonium compounds, quinomethionate, quinoxyfen, quintozene, sipconazole, sodium pentachlorophenate, spiroxamine, streptomycin, sulfur, tebuconazole, tecloftalam, tecnazene, tetraconazole, thiabendazole, thifluzamide, thiophanate-methyl, thiram, timibenconazole, tolclofos-methyl, tolylfluanid, triadimefon, triadimenol, triazbutil, triazoxide, tricyclazole, tridemorph, triforine, triflumizole, triticonazole, validamycin A, zineb, and ziram.

The termite control agent described above can be widely used for applications such as control of termites and prevention of damage by termites (such as feeding damage) and the like. The termite control agent according to the present invention can be applied to both of soil treatment and xylem treatment. Parts for which termites are controlled include, without limitation, for example, soil (such as ground surface); for example, wood; for example, foundation structure parts, superstructure parts and subsurface structure parts in buildings (architectural structures; i.e. houses, warehouses, gates, walls and their attached structures); for example, buried objects of buildings as annexed equipment of buildings; and, for example, habitats and generating areas of termites. Specifically, the termite control agent can be used suitably, for example, as a treating agent for soil, or a treating agent for various wood used for general industry and for civil engineering.

In the case of soil treatment, the agent is generally scattered on the surface of soil to form a protection layer against termites. As for xylem treatment, there are two methods; one is spraying the agent on the surface of wood using of a sprayer or applying the agent by means of a brush or the like, and the other is perforating the wall of wood and injecting the agent liquid. Further, it is possible to apply the termite control agent to a sheet and laying the sheet on the surface of soil. It is preferable to use the termite control agent in a liquid-type or spray-type form, and the liquid-type form agent can be scattered by using a sprayer.

A target of control by the termite control agent is not particularly limited provided that it is an insect belonging to Isoptera, and specifically, examples are those belonging to Rhinotermitidae such as Formosan subterranean termite (Coptotermes formosanus) and Japanese subterranean termite (Reticulitermes speratus), and those belonging to Kalotermitidae such as Incisitermes minor and Cryptotermes domesticus.

Note that control against termites (control of termites and prevention of damage by termites) is meant to include not only killing termites but also repelling and antifeeding.

Amount of the termite control agent to be used is, in the case of soil treatment, preferably 1 to 500 g/m² of the particles of the invention, more preferably 10 to 200 g/m², and most preferably 20 to 150 g/m², but not limited thereto. In the case of xylem treatment, an amount of the particles of the invention is preferably 1 to 100 g/m², more preferably 3 to 80 g/m², and most preferably 5 to 50 g/m².

The method in which the termite control agent of the invention is used by the spray method is not specifically limited; examples include a conventionally known method where liquid of the particles of the invention dispersed in a solvent such as water is contained in a container made of plastic, metal, glass or the like, equipped with a nozzle capable of spraying in the form of mist. Further, injection gas used in the injection method is not specifically limited; examples include CFC-11, CFC-12, CFC-21, CFC-22, CFC-113, CFC-114, methyl chloride, isobutane, carbon dioxide gas, liquefied petroleum gas, and dimethyl ether. These injection gases may be used singly or in combination of two or more kinds.

It is preferable that the termite control agent of the invention contains macromolecules in view of increasing persistence of the control effect against termites. While varieties of macromolecules can be used as the macromolecules, water-soluble macromolecules are preferable, and polyvinyl alcohol is most preferable. Macromolecular polyvinyl alcohol is a vinyl resin having hydroxyl groups, obtainable through saponification of polyvinyl acetate which, in turn, is obtained by polymerizing popular vinyl acetate. Degree of polymerization and degree of saponification of macromolecular polyvinyl alcohol can be set variously. Contained amount of polyvinyl alcohol in the termite control agent liquid is preferably 0.5 to 20% by weight, more preferably 1 to 15% by weight, and most preferably 2 to 10% by weight.

### EXAMPLES

Hereafter, the present invention will be described in detail with reference to examples. Note, however, that the invention is not limited to these examples.

### Example 1

Synthesis of particles of the invention: A-1, A-2, A-3 and A-4

Total amount of 2 L of a mixed aqueous solution of zinc nitrate and aluminum nitrate (Zn²⁺=0.95 mol/L, Al³⁺=0.05 mol/L) was added to a mixed solution of 2 L of a 2 mol/L aqueous solution of sodium hydroxide and 0.5 L of a 0.6 mol/L aqueous solution of sodium carbonate under stirring in a period of about one minute (time for addition), and the compounds were subjected to a reaction (reaction temperature: about 30° C.). Reaction product slurry obtained was filtrated under reduced pressure, washed with water, and dried. Powder obtained by pulverizing the dried substance was sintered at 400° C. for 1.5 hours to obtain particles A-1 of the invention. In a similar manner as A-1, except that the time for addition was 1.5 minutes and the reaction temperature was 45° C., complex metal oxide A-2 was obtained. In a similar manner as A-1, except that the time for addition was 3 minutes and the reaction temperature was 60° C., complex metal oxide A-3 was obtained. Further, in a similar manner as A-1, except that the amount ratio of zinc nitrate and aluminum nitrate was changed, particles A-4 of the invention were obtained.

Synthesis of particles of the invention: M-1

Using magnesium ions instead of aluminum ions, particles of the invention M-1 having composition of (ZnO)_{0.15}(MgO)_{0.85} and primary particle size of 0.08 μm were obtained.

Confirmation of being Solid Solution

Measurement of particles of the invention A-1 to A-4 and M-1 by powder X-ray diffractometry revealed that intensities of diffracted characteristic X-rays of zinc oxide and aluminum oxide or magnesium oxide were 10% or less compared to intensities of corresponding diffracted rays of a mixture of zinc oxide and aluminum oxide or magnesium oxide of the same composition, and therefore, it was confirmed that the particles of the invention were solid solution.

### Particles of the Invention

Particles of the invention A-1 to A-4 are compounds represented by Formula (1) of the invention.

| Compound | Value of x in | Average primary | |
|---|---|---|---|
| No. | Formula (1) | particle size (μm) | |
| A-1 | 0.05 | 0.02 | present invention |
| A-2 | 0.05 | 0.07 | present invention |
| A-3 | 0.05 | 0.09 | present invention |
| A-4 | 0.16 | 0.10 | present invention |
| M-1 | | 0.06 | present invention |
| Z-1 | zinc oxide | 0.04 | present invention |

Average size of primary particles of the particles of the invention was obtained from scanning electron micrographs.
Z-1 is fine particle zinc oxide MZ-300 (produced by Tayca Corporation).

### Example 2

### Preparation of Aqueous Dispersion Liquid of Particles of the Invention: Termite Control Agent

Purified water was placed in a container, 1% by weight of sodium alkylbenzenesulfonate, which is an anionic surfactant, was added thereto, particles A-1 of the invention were further added, balls made of alumina having a diameter of 0.5 mm were loaded, the container was placed on a rotary roller, and a rotating dispersion treatment was performed for 48 hours according to a routine procedure of a ball mil, and thereafter, 2% by weight of Gohsenol KH-17, which is synthetic macromolecular polyvinyl alcohol produced by Nippon Gohsei, was contained therein and mixed and dispersed according to a routine procedure, and thus, aqueous dispersion liquid Y-1 (termite control agent) of particles of the invention A-1 was prepared. Concentration of A-1 was 1% by weight. Aqueous dispersion liquids Y-2 to Y-6 (termite control agent) of the invention and of compounds of Comparison Examples were obtained in a similar manner as Y-1, except that A-2 to A-4, M-1 and Z-1 were used, respectively, instead of particles of the invention A-1.

### Comparison Example 1

### Termite Control Agent Containing Calcium Chloride

Termite control agent CY-1 (termite control agent containing calcium chloride) of Comparison Example, which is an aqueous suspension containing 1.0% by weight of Hiba oil (‘Kisei PROSOL·N’ produced by Kiseitec Co., Ltd containing Hiba oil, content of Hinokitiol: 0.5% by weight; isoparaffin hydrocarbon containing natural essential oil such as Hiba oil and Hinoki oil), 40.0% by weight of calcium chloride (reagent produced by Sanuki Kasei Co., Ltd., CaCl₂), and 3.0% by weight of polyoxyethylenealkyl ether (‘Peresoft NSC’ produced by Miyoshi Oil & Fat Co., Ltd.) as a surfactant, was obtained.

### Comparison Example 2

### Termite Control Agent Containing Piper Methysticum Essence

A whole body of Piper methysticum was shredded finely, 5 parts by weight of ethanol relative to one part of the shredded Piper methysticum was added, and refluxed for 8 hours. After the reflux, solid contents were removed by filtration, the filtrate was concentrated by an evaporator, and thus Piper methysticum essence was extracted. Five parts by weight of the Piper methysticum essence and 10 parts by weight of capric acid (trade name tunac 10-98′, produced by Kao Corporation) were used and 45 parts by weight of propylene glycol (produced by Wako Pure Chemical Industries, Ltd.), 10 parts by weight of Sylysia 380 (micronized silica, produced by Fuji Sylisia Chemical Ltd.), 5 parts by weight of Sanisol C (quaternary ammonium salt-type surfactant, produced by Kao Corporation), 6 parts by weight of Rheodol TW-O120V (polyoxyethylene sorbitan fatty acid ester, produced by Kao Corporation), 6 parts by weight of PEG-400 (polyoxyethylene glycol, average molecular weight of about 400, produced by Sanyo Chemical Industries Ltd.), 9 parts by weight of Rheogic H250 (sodium polyacrylate, produced by Nihon Junyaku Co., Ltd.), and 4 parts by weight of distilled water were added and dispersed uniformly. Thus, suspension CY-2 of micronized silica carrying Piper methysticum essence (termite control agent containing Piper methysticum essence) was obtained. This suspension contained 5 parts by weight of Piper methysticum essence.

### Example 3

### Measurement Method of Termite Control Effect: Wood Anti-Termite Test Method

A test was conducted in the following procedure.

(1) The termite control agent (dispersion liquid) obtained in Example 1 was applied to surfaces of a wood chip (1 cm in both longitudinal length and lateral length of its bottom face and 2 cm in height) of Pinus densiflora having been dried beforehand. The wood chip thus treated with the agent was dried at 60° C. for 48 hours, and then weight (W1) was measured.

(2) Silica sand whose water content had been adjusted to 8%, which is the optimum water content for termite activity, was placed in a plastic container, and the wood chip was put on the surface of the silica sand.

(3) On the silica sand 200 worker termites and 20 soldier termites of Formosan subterranean termite were released to commence the wood anti-termite test. In the test, number of samples was three.

(4) After the release, behavior and number of death heads of the Formosan subterranean termite were observed for 21 days.

(5) When 21 days have passed after the release, the wood chip was taken out, dried at 60° C. for 48 hours, and then weight (W2) of the wood chip was measured. Decrease rate of weight was obtained.

Decrease rate of weight (%)=((W1−W2)/W1)×100

Further, as a control test, the wood anti-termite test was conducted, in a similar manner as above, on a wood chip of Pinus densiflora which had not been treated with the agent. It can be said that the higher the rate of death of the termites and the lower the decrease rate of weight of the wood chip, the larger the termite control effect, and that if the decrease rate of weight is less than 3%, anti-termite effect of the termite control agent is high.

### Example 4

### Result of Termite Control Test: Wood Anti-Termite Test Method

Using termite control agents Y-1 to Y-6 described in Example 2 and termite control agents CY-1 and CY-2 described in the Comparison Examples 1 and 2, the wood anti-termite test method described in Example 3 was conducted. The termite control agents were applied to surfaces of wood chips of Pinus densiflora. Amount applied to the surface of the wood chip of Pinus densiflora was 8 g/m² for the particles of the invention in Y-1 to Y-6, 150 g/m² for calcium chloride in CY-1 and 15 g/m² for Piper methysticum essence in CY-2. Further, a test was also conducted on an untreated wood chip of Pinus densiflora to which no termite control agent had been applied.

### Result of Test

| | | | Decrease | |
|---|---|---|---|---|
| Termite | Death | Number of days | rate of | |
| control | rate | needed for 100% | weight | |
| agent | (%) | death rate | (%) | |
| Y-1 | 100 | 2 | 0.5 | present invention |
| Y-2 | 100 | 3 | 0.3 | present invention |
| Y-3 | 100 | 3 | 0.4 | present invention |
| Y-4 | 100 | 3 | 0.5 | present invention |
| Y-5 | 100 | 8 | 1.8 | present invention |
| Y-6 | 100 | 15 | 3.5 | present invention |
| CY-1 | 10 | | 20.5 | Comparison Example |
| CY-2 | 100 | 18 | 4.5 | Comparison Example |
| untreated | 3 | | 30.0 | Comparison Example |

Death rate of termite control agents Y-1 to Y-6 of the invention was 100%, and the decrease rate of weight was smaller than that of CY-1, CY-2 and the untreated sample in the Comparison Examples, and thus, preferable. Further, in comparing number of days needed for the death rate to reach 100%, each of termite control agents Y-1 to Y-6 of the invention was shorter than the result of any of the Comparison Examples. Note that CY-1 and the untreated sample showed death rate of 10% or lower, the control effect being low, and thus, were not preferable. From these results, the termite control agents of the present invention were superior to the termite control agents of the Comparison Examples and the untreated sample in both of the indicators of death rate and decrease rate of weight, and thus, preferable. Further, as for the degree of effect, the termite control effect is sufficiently high. However, control agent Y-6 of the invention was large, in comparison with Y-1 to Y-5, in number of days needed for the death rate to reach 100% as well as the decrease rate of weight, meaning not preferable. The particles of the invention rank as GRAS (Generally Recognized As Safe) compound of U. S. Food and Drug Administration, meaning harmless to health of the human body, and are preferable also in this regard.

1. (canceled) .

2. A termite control agent comprising particles containing two or more kinds of oxide or hydroxide which contain at least one kind of each of a first component and a second component, wherein
the first component consists of zinc oxide or zinc hydroxide, and
the second component consists of at least one kind of oxide or hydroxide of magnesium, calcium and aluminum.

3. A termite control agent of claim 2, wherein the second component of the particles is oxide or hydroxide of aluminum.

4. A termite control agent of claim 2, wherein the particles are oxide.

5. A termite control agent of claim 4, wherein the particles are represented by the following general formula (1):
(ZnO)₁₋ₓ(Al₂O₃)ₓ (1)
where x satisfies 0.005≦x<0.2.

6. A termite control agent of claim 2, wherein the particles are solid solution.

7. A termite control agent of claim 2, wherein primary particle size of the particles is 0.01 to 0.5 μm.

8. A termite control agent of claim 2, wherein the termite control agent contains polyvinyl alcohol.

9. An industrially applicable preparation containing a termite control agent of claim 2, and a manufacturing method thereof.

10. A termite control agent in container equipped with spray means wherein a liquid composition containing a termite control agent of claim 2 is contained in the container.
